(19) United States
(12) Patent Application Publication
(10) Pub. No.: US 2024/0169721 A1
(43) Pub. Date: May 23, 2024

(54) COMPUTER-IMPLEMENTED METHOD FOR PROVIDING CORRECTED PLANT-RELATED INDEX DATA

(71) Applicant: BASF AGRO TRADEMARKS GMBH, Ludwigshafen (DE)

(72) Inventors: Mojtaba KARAMI, Köln (DE); Sayan MUKHOPADHAYA, Köln (DE); Damon RAEIS-DANA, Köln (DE); Nicolas WERNER, Köln (DE); Fabian Johannes SCHAEFER, Langenfeld (DE); Jeffrey Thomas SPENCER, Bellefonte, PA (US)

(21) Appl. No.: 18/283,633

(22) PCT Filed: Mar. 31, 2022
(86) PCT No.: PCT/EP2022/058628

§ 371 Date: Sep. 22, 2023

(30) Foreign Application Priority Data
Mar. 31, 2021 (EP) 21166298.6

(51) Int. Cl. G06V 20/10; A01B 79/00; G06V 10/70; G06V 20/13

(52) U.S. Cl. CPC G06V 20/188; A01B 79/005; G06V 10/70; G06V 20/13

(57) ABSTRACT

Computer-implemented method for providing corrected plant-related index data, comprising the steps of: providing initial plant-related index data for an agricultural field, preferably based on at least one satellite image; and correcting the initial plant-related index data for the agricultural field at least based on historical plant-related index data for the agricultural field and providing corrected plant-related index data.

### FIELD OF THE INVENTION

The present disclosure relates to a computer-implemented method for providing corrected plant-related index data, a system for providing corrected plant-related index data, a respective computer program element, a use of corrected plant-related index data as input data for providing an application map of an agricultural field, a use of corrected plant-related index data as input data for an agronomic simulation model with respect to an agricultural field and to a control device performing such a computer-implemented method for providing corrected plant-related index data.

### BACKGROUND OF THE INVENTION

Plant-related indexes, like the leaf area index (LAI), are widely used in the state of the art to make a variety of agronomic decisions. For example, the LAI, which is usually defined, as the total one-sided leaf area per unit ground area, is one of the most important biophysical parameters characterizing a canopy. Since the LAI directly quantifies the plant canopy structure, it is highly related to a variety of canopy processes, such as evapotranspiration, light interception, photosynthesis, respiration and leaf litter fall. Remotely sensed estimations of the LAI greatly assist the application of LAI as input data for photosynthesis models, crop growth simulation models, evapotranspiration, estimation of net primary productivity and vegetation/biosphere functioning models for large areas, at cost effective way. In this respect, the LAI may be estimated based on the reflectance characteristics of the visible vegetation from on satellite images. Further important plant-related parameters are, for example, the leaf chlorophyll content (LC), the canopy chlorophyll content (CCC) or the normalized difference vegetation index (NDVI).

However, in view of this, it is found that a further need exists to provide a method for improving the estimation of a plant-related index, e.g. a leaf area index (LAI), when the plant-related index, e.g. LAI, is estimated based in satellite images/data.

### SUMMARY OF THE INVENTION

It is therefore an object of the present invention to provide a method for improving the estimation of a plant-related index, e.g. the LAI, in particular when the plant-related index, e.g. the LAI, is estimated based on satellite images/data.

These and other objects, which become apparent upon reading the following description, are solved by the subject-matter of the independent claims. The dependent claims refer to preferred embodiments of the present disclosure.

According to a first aspect of the present disclosure a computer-implemented method for providing corrected plant-related index data (e.g. leaf area index data), comprising the steps of: providing initial/generic plant-related index data (e.g. leaf area index (LAI) data) for an agricultural field; and correcting the initial/generic plant-related index data (e.g. LAI data) for the agricultural field at least based on historical plant-related index data (e.g. LAI data) for the agricultural field and providing corrected/improved plant-related index data (e.g. LAI data).

In other words, the present disclosure proposes a correction, improvement or fine-tuning of initial/generic plant-related index data, e.g. LAI data, in light of historical plant-related index data, e.g. historical LAI data, of an area/field. In this respect, it has been found that this can improve the accuracy of plant-related index data, e.g. LAI data, thus obtained/corrected. The use of historical observations of the plant-related index, e.g. LAI, e.g. one observation, is proposed in order to compensate for inaccuracies, e.g. arising from unaccounted atmospheric variability, satellite sensor calibration issues, and other sources of error, aiming to achieve a more accurate estimate. Using these historical observations of the plant-related index, e.g. LAI, in addition to the initial estimate obtained, by applying for example a statistical model, it is possible to provide an improved/corrected estimation of the plant-related index data. The term plant-related index is to be understood broadly and refers to any plant-related index/biophysical parameter relating to a crop plant which can be physically measured. The term initial plant-related index data is to be understood broadly and refers to plant-related index data, which have not yet been corrected/adjusted in the light of historical plant-related index data. The term corrected/improved plant-related index data is also to be understood broadly and refers to any plant-related index data, which has been corrected/improved based on historical plant-related index data. The term “correcting” the initial/generic plant-related index data is also to be understood broadly and may also include validating or verifying of the initial/generic plant-related index data.

In an embodiment of the present disclosure, the plant-related index data is: leaf area index (LAI) data, leaf chlorophyll content (LC) data, canopy chlorophyll content (CCC) data, normalized difference vegetation index (NDVI) data, canopy biomass data, canopy nitrogen content data, leaf canopy content data of the plant or vegetation water content data. In an example, the LAI data is provided in m²/m², the leaf chlorophyll contend is provided in μg per m² of leaf.

In a preferred embodiment of the present disclosure, the plant-related index data is leaf area index (LAI) data.

In an embodiment of the present disclosure, the initial/generic plant-related index data, e.g. LAI data, is based on satellite images, wherein the satellite images are preferably in the visible and/or near infrared range (NIR). The method for estimating the plant-related index, e.g. LAI, that has become widespread is based on the evaluation of satellite images. Here, often the reflectance characteristics of the visible vegetation from on satellite images are used to estimate the plant-related index, e.g. LAI. Although this method is preferred, the present disclosure is not limited thereto. In an embodiment of the present disclosure, the initial plant-related index data for the agricultural field is obtained by using a calibrated mathematical model between the plant-related index data and surface reflectance bands of the at least one satellite image. If the effects of atmospheric variations on one or more satellite images are not accounted for at the source, standard state-of-the-art atmospheric correction methods may be performed removing/reducing the impact of the atmosphere from the satellite images and obtain a so-called “surface reflectance”. Since such corrected surface reflectance are more reliable and the effect of atmospheric conditions, for example water vapor or aerosols, on the quality of the estimate may be minimized, it is preferred to use such atmospherically corrected surface reflectance. However, this is not necessarily a mandatory step. Alternatively, the non-corrected images, i.e., so-called “top of atmosphere reflectance images”, may also be used, and models to obtain the plant-related index data from such satellite images may also be used in the present disclosure. In a further embodiment of the present disclosure, the calibrated mathematical model is a calibrated machine learning model and the initial plant-related index data, e.g. the leaf area index data, for the agricultural field is obtained by using the calibrated machine learning model based on plant-related index data, e.g. leaf area index data, and surface reflectance bands of the at least one satellite image, wherein the machine learning model is preferably: an artificial neural network (ANN), multiple linear regression, random forest regression, or an approach that is able to establish a statistical relationship to predict leaf area index data.

A generic model may be applied at image level (e.g. on the entire image) to obtain a first estimate of the plant-related index data, e.g. LAI data, i.e. to obtain the initial plant-related index data. From a methodological point of view, the generic model may consist of explicitly defined mathematical formula defining the relationship between the plant-related index and reflectances in different bands of the spectrum, or a black-box statistical/machine learning model that defines such relationship, e.g. random forest, artificial neural networks, etc. The generic model may also make use of different bands of the sensor, depending on the availability of the band in the case of a given satellite sensor. However, the common feature of the generic model is that either way, it is calibrated using training data to infer the plant-related index data, e.g. LAI data, for each pixel of the image from reflectance, as explained in more detail below. The term generic model is used to indicate that this model estimates the plant-related index data, e.g. LAI data, for all pixels of the image using the reflectance as input. The reason for this is that while target type and state, e.g. crop type and its growth stage, are highly important in defining the relationship between reflectance and the plant-related index data, e.g. LAI data, these information are often unknown/unavailable for every single pixel in an image. Thus, the initial plant-related index data is ready for further processing. These plant-related index data can already refer to one specific agricultural field or encompass further geographical areas. If the latter is the case, the initial plant-related index data may be narrowed down to a specific agricultural field in a subsequent step, as shown, for example, in the preferred embodiment of the present disclosure with respect to LAI data.

In an embodiment of the present disclosure, the calibrated mathematical model is adapted to different crop varieties, crop types, growth stage, soil conditions and/or data sources, i.e. a crop-specific plant-related index, e.g. LAI, correction model. Due to the impact of canopy structure on light diffusion and reflectance processes of the canopy, crop type is one of the most important factors in determining the relationship between satellite-observed reflectance and the plant-related index, e.g. LAI. Depending on the implementation, the crop-specific plant-related index correction models may comprise either i) a look-up-table of polynomial coefficients that are specific to a crop type, that are then applied on the initial plant-related index estimations output to “scale” the initial plant-related index estimations to crop-specific plant-related index estimates, or ii) a more complex model that inputs certain reflectance bands, e.g. NIR, red-edge, in addition to crop-type. The use of the latter approach may be more accurate whereas the first approach may be more computationally efficient.

In an embodiment of the present disclosure, the historical plant-related index data of the agricultural field is based on satellite images, wherein the satellite images are preferably in the visible and/or near infrared range (NIR). The historical observations of the plant-related index can be sourced, for example, from previous satellite-based observations, or in-situ sources including but not limited to direct measurements, in-situ devices generating the plant-related index estimates by recording surface reflectance, or computer vision techniques applied on proximal high-resolution imagery collected from the field.

In an embodiment of the present disclosure, the historical plant-related index data of the agricultural field comprises satellite images of the agricultural field from a period between 1 and 5 years, preferably between 2 year and 3 years, or especially preferred satellite images from the last year. In a further embodiment of the present disclosure, the historical plant-related index data of the agricultural field comprises satellite images of the agricultural field from a period between 1 and 30 days, preferably between 1 and 15 days, and especially preferred satellite images from the last 10 days.

In an embodiment of the present disclosure, the historical plant-related index data of the agricultural field comprises satellite images of the agricultural field from the actual growing season starting from the seeding time.

In an embodiment of the present disclosure, the method is further comprising: providing boundary data based on the historical plant-related index data representing boundaries for the corrected plant-related index data, wherein the historical plant-related index data is preferably crop-specific plant related index data.

In an embodiment of the present disclosure, the method is further comprising: providing an uncertainty-probability value based on the historical plant-related index data for the reliability of the corrected plant-related index data, wherein the historical plant-related index data is preferably crop-specific plant related index data.

In an embodiment of the present disclosure, the historical plant-related index data are (only) crop-specific plant-related index data.

In an embodiment of the present disclosure, correcting the initial plant-related index data for the agricultural field is based on a correction term based on a statistical model at least derived from the historical plant-related index data of the agricultural field. Such statistical models may exploit the learned expected/normal temporal behavior of the plant-related index in order to improve the plant-related index estimation for the corrected plant-related index. It is well-known that the temporal variability of the actual plant-related index is very low in short time spans, and even over longer time spans it follows a relatively predictable pattern that can be characterized using mathematical representations or non-parametric statistical models. Therefore, in terms of implementation of a statistical model, the simplest approach is that an explicitly defined mathematical formula, e.g. a logistic function, may be used to create a smooth fit of the current provided plant-related index, e.g. LAI, along with historical observations, to create a localized model of the plant-related index, e.g. LAI, as a function of time. Subsequently, this model may be used to predict an improved/corrected estimate of the plant-related index data for an observation time. Alternatively, in a more complex implementation, a non-parametric model, e.g. spline or random forest, may be used to achieve the same goal.

In an embodiment of the present disclosure, the correction term is additionally based on predefined rules in view of the typical ranges with respect to the crop variety, crop type, growth stage and/or soil condition. One further important aspect of the statistical model is how to account for the fact that the so-called “expected/normal” behavior of the plant-related index, e.g. LAI, varies under different circumstances. For example, patterns of plant-related index variation over a given time span would be different among different crops, and among different growth stages, and under different weather conditions. Whereas rapid increase in the plant-related index can only be interpreted as noise in a particular growth stage and removed using the statistical model, in another growth stage it is only expected and therefore the statistical model should not correct for such an increase. In order to reflect such constrains, two approaches may be used: i) sub-models approach, and ii) machine learning approach. The sub-models approach (i) is essentially an explicitly defined decision tree, that uses different parametrization for the statistical model depending on the constrains. For example, the use of crop-specific statistical models, and/or two or more different statistical models depending on whether the crop is in greening or senescing phase. Such accounting for the target specifities at the field level, allows for a more refined and targeted application of the statistical model. For example, the statistical model may apply a limit on the daily decrease rate of the plant-related index, e.g. LAI, during certain growth stages when the plant-related index, e.g. LAI, normally tends to decrease or can as well limit the plant-related index, e.g. LAI, of a crop within a viable range specific to that crop and/or growth stage. In the machine learning approach (ii), statistical model is essentially a machine learning model, e.g. a random forest regression model or a deep learning model, that performs an improved estimation of the plant-related index. The inputs to such model are therefore not only the current plant-related index observation undergoing correction and its historical set but a set of auxiliary target-specific information. For example, an implementation of a statistical model could involve a machine learning model that has as inputs the current remotely sensed the plant-related index of the field, 4 last available plant-related index observations of the field, crop growth stage, and weather conditions and outputs an improved/corrected estimation of the field plant-related index level. Thus, in the machine learning approach, statistical model treats the auxiliary information as individual model inputs and “learns” the nonlinear relationship between target-specific auxiliary information, and the set of input plant-related index values on the one hand, and the actual plant-related index level of the field on the other.

Notably, a machine-learning model/algorithm may comprise decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data.

In an embodiment of the present disclosure, the dataset constituting the historical plant-related index data is obtained from any combination of different available sources, including satellite images, unmanned aerial vehicles, agricultural robots, handheld or mounted cameras, and/or other measurement devices located on the agricultural field. In a further embodiment of the present disclosure, a processor queries, identifies, obtains, standardizes, and outputs the relevant historical plant-related index of possibly various origins to the correction algorithm.

In an embodiment of the present disclosure, the calibrated mathematical model and/or the calibrated machine learning model estimating plant-related index data from reflectance bands are either continuously or periodically updated, wherein independent measurements of plant-related index data available in the system and their corresponding reflectance bands are fed into a calibration algorithm, wherein the calibration algorithm uses the fed data to improve the performance of the calibrated mathematical model, preferably of the calibrated machine learning model.

A further aspect of the present disclosure relates to a system for providing corrected plant-related index data, e.g. LAI data, comprising: at least one input interface for providing initial plant-related index data, e.g. LAI data, for an agricultural field; and at least one processing unit configured to correct the initial plant-related index data, e.g. LAI data, for the agricultural field at least based on historical plant-related index data, e.g. LAI data, for the agricultural field and providing corrected plant-related index data, e.g. LAI data. With regard to the details of such a system, reference is made to the above remarks on the method, which apply here correspondingly.

A further aspect of the present disclosure relates to a computer program element which when executed by a processor in such a system is configured to carry out a method as explained above. The computer program element might be stored on a computer unit, which might also be part of an embodiment. This computing unit may be configured to perform or induce performing of the steps of the methods described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the invention covers both, a computer program that right from the beginning uses the invention and computer program that by means of an update turns an existing program into a program that uses invention. Further on, the computer program element might be able to provide all necessary steps to fulfill the procedure of an exemplary embodiment of the methods as described above. According to a further exemplary embodiment of the present invention, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention. Also here, with respect to the details of such a computer program element, reference is made to the above remarks on the method, which apply here correspondingly. In a preferred embodiment of the present disclosure, the plant-related index data is leaf area index (LAI) data.

A further aspect of the present disclosure relates to a use of improved/corrected plant-related index data, e.g. LAI data, provided according to a method described above as input data for providing an application map of the agricultural field. A further aspect of the present disclosure relates to a use of corrected plant-related index data, e.g. LAI data, provided according to a method described above as input data for an agronomic simulation model with respect to the agricultural field, wherein the simulation model is preferably a yield simulation model, a disease simulation model. Finally, a further aspect of the present disclosure relates to a control device for controlling an agricultural equipment/vehicle based on an application map of an agricultural field based on corrected plant-related index data, e.g. LAI data, provided an according to a method described above input data. Also here, with respect to the details of such improved/corrected plant-related index data, e.g. LAI data, reference is made to the above remarks on the method, which apply here correspondingly. In a preferred embodiment of the present disclosure, the plant-related index data is leaf area index (LAI) data.

The term “agricultural field” is understood to be any area in which organisms, particularly crop plants, are produced, grown, sown, and/or planned to be produced, grown or sown. The term “agricultural field” also includes horticultural fields, silvicultural fields and fields for the production and/or growth of aquatic organisms. In a preferred embodiment, agricultural field is an area in which crop plants are produced, grown, sown, and/or planned to be produced, grown or sown.

### BRIEF DESCRIPTION OF THE DRAWINGS

In the following, the present disclosure is described exemplarily with reference to the enclosed figure, in which

FIG. 1 is a schematic overview of the steps of a method according to the present disclosure;

FIG. 2 is an illustration of an improved/corrected LAI for an observation time;

FIG. 3 is an illustration of an improved/corrected LAI for an observation time;

FIG. 4 is an illustration for a correction of LAI using Random Forest and independently provided field information;

FIG. 5 is a schematic diagram of a cost function used for model calibration using ground-truth; and

FIG. 6 is a schematic illustration of calibrated model parameters of the model components.

### DETAILED DESCRIPTION OF EMBODIMENT

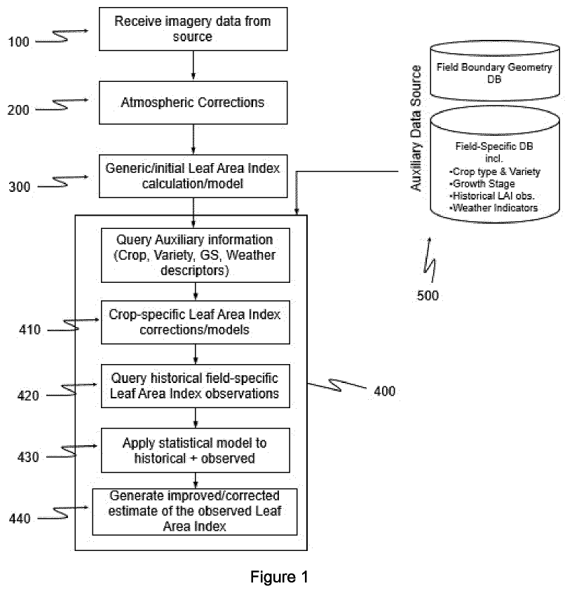

In FIG. 1, an overview of the steps of a preferred embodiment of a method according to the present disclosure is shown. In the preferred embodiment, the method according to the present disclosure is explained in view of the leaf area index (LAI) as plant-related index. However, the following explanations and approaches also apply when correcting plant-related indexes other than the leaf area index. In a preferred embodiment of the present disclosure, the plant-related index data is leaf area index (LAI) data.

In a step 100, satellite imagery is obtained/provided from a source. If the effects of atmospheric variations on one or more satellite images are not accounted for at the source, in a step 200, standard state-of-the-art atmospheric correction methods, may be performed removing/reducing the impact of the atmosphere from the satellite images and obtain a so-called “surface reflectance”. Since such corrected surface reflectance are more reliable and the effect of atmospheric conditions, for example water vapor or aerosols, on the quality of the estimate may be minimized, it is preferred to use such atmospherically corrected surface reflectance. However, this is not necessarily a mandatory step. Alternatively, the non-corrected images, i.e., so-called “top of atmosphere reflectance images”, may also be used, and models to obtain LAI data from such satellite images may also be used in the present disclosure.

In a step 300, a generic model may be applied at image level (on the entire image) to obtain a first estimate of LAI data, i.e. to obtain the initial LAI data. From a methodological point of view, the generic model may consist of explicitly defined mathematical formula defining the relationship between LAI and reflectances in different bands of the spectrum, or a black-box statistical/machine learning model that defines such relationship, e.g. random forest, ANN, etc. The generic model may also make use of different bands of the sensor, depending on the availability of the band in the case of a given satellite sensor. However, the common feature of the generic model is that either way, it is calibrated using training data to infer LAI data for each pixel of the image from reflectance, as explained in more detail below. The term generic model is used to indicate that this model estimates LAI data for all pixels of the image using the reflectance as input. The reason for this is that while target type and state, e.g. crop type and its growth stage, are highly important in defining the relationship between reflectance and LAI data, these information are often unknown/unavailable for every single pixel in an image. Thus, at the end of step 300, the initial LAI data is ready for further processing. These LAI data can already refer to one specific agricultural field or encompass further geographical areas. If the latter is the case, the initial LAI data may be narrowed down to a specific agricultural field in a subsequent step, as shown, for example, in the preferred embodiment of the present disclosure.

In the shown preferred embodiment, corrections of the initial LAI data are performed, by performing operations 400 on each agricultural field separately, and therefore make the LAI estimates more specific and more accurate. Whether or not to cover all agricultural fields in the image depends on the purpose of the system. But regardless of the implementation, often a relational database 500 stores information about which field geometries are relevant for an image (or vise-versa) and in addition to, if available, certain auxiliary information about those field geometries, e.g. crop type, growth stage, previous LAI estimates.

As a first step of improving the specifity of the initial LAI data/estimates, a crop-dependent scaling of the initial LAI data/estimate may be performed using crop-specific LAI correction models 410. Due to the impact of canopy structure on light diffusion and reflectance processes of the canopy, crop type is one of the most important factors in determining the relationship between satellite-observed reflectance and LAI. Depending on the implementation, the crop-specific LAI correction models 410 may comprise either i) a look-up-table of polynomial coefficients that are specific to a crop type, that are then applied on the initial LAI estimations output to “scale” the initial LAI estimations to crop-specific LAI estimates, or ii) a more complex model that inputs certain reflectance bands, e.g. NIR, red-edge, in addition to crop-type. The use of the latter approach may be more accurate whereas the first approach may be more computationally efficient.

According to the present disclosure, the use of historical observations of LAI, e.g. at least one observation, is proposed in order to compensate for inaccuracies, e.g. arising from unaccounted atmospheric variability, satellite sensor calibration issues, and other sources of error, aiming to achieve a more accurate estimate. Using these historical observations of LAI in addition to the estimate obtained from the image, by applying for example a statistical model 430, it is possible to provide an improved/corrected estimation of LAI. The historical observations of LAI can be sourced, for example, from previous satellite-based observations, or in-situ sources including but not limited to direct measurements, in-situ devices generating LAI estimates by recording surface reflectance, or computer vision techniques applied on proximal high-resolution imagery collected from the field. Regardless of the source of historical LAI observations, in the statistical model 430, a set of historical LAI observations with known observation time stamps, alongside the crop-specific LAI correction models 410, the generated LAI and its time-stamp, may be input. Both sets may be standardized to be comparable. For example, by referring to a specific location in the field or relate to the average level of LAI for the agricultural field.

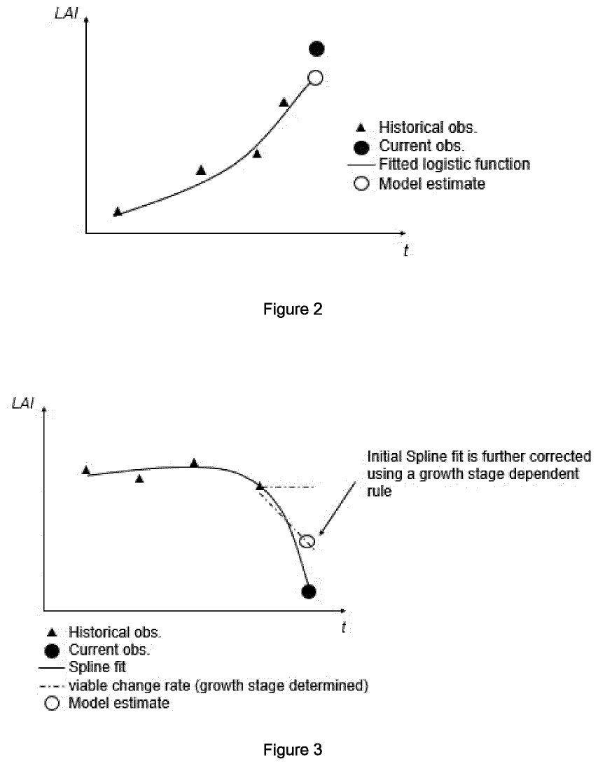

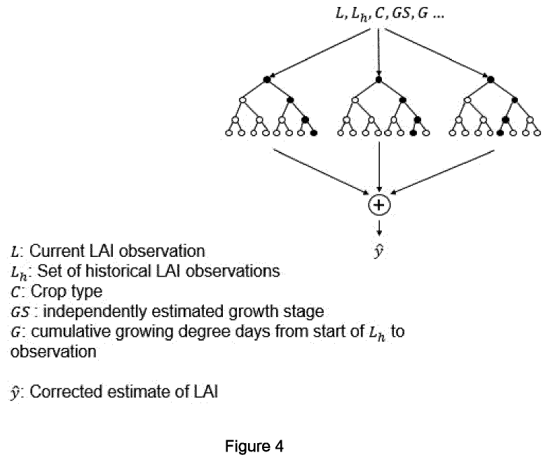

From a methodological perspective, the statistical model 430 is a statistical model, which exploits the learned expected/normal temporal behavior of LAI in order to improve the LAI estimation for the corrected LAI. It is well-known that the temporal variability of the actual LAI is very low in short time spans, and even over longer time spans it follows a relatively predictable pattern that can be characterized using mathematical representations or non-parametric statistical models. Therefore, in terms of implementation of the statistical model 430, the simplest approach is that an explicitly defined mathematical formula, e.g. a logistic function, may be used to create a smooth fit of the current, by step 410 provided LAI, along with historical observations, to create a localized model of LAI as a function of time. Subsequently, this model may be used to predict, in an step 440, an improved/corrected estimate of LAI for the observation time, as shown in FIG. 2. Alternatively, in a more complex implementation, a non-parametric model, e.g. spline or random forest, may be used to achieve the same goal, as shown in FIGS. 3 and 4.

One further important aspect of the statistical model 430 is how to account for the fact that the so-called “expected/normal” behavior of LAI varies under different circumstances. For example, patterns of LAI variation over a given time span would be different among different crops, and among different growth stages, and under different weather conditions. Whereas rapid increase in LAI can only be interpreted as noise in a particular growth stage and removed using the statistical model 430, in another growth stage it is only expected and therefore the statistical model 430 should not correct for such an increase. In order to reflect such constrains, two approaches may be used: i) sub-models approach, and ii) machine learning approach. The sub-models approach (i) is essentially an explicitly defined decision tree, that uses different parametrization for the statistical model 430 depending on the constrains. For example, the use of crop-specific statistical models 430, and/or two or more different statistical models 430 depending on whether the crop is in greening or senescing phase. Such accounting for the target specifities at the field level, allows for a more refined and targeted application of the statistical model 430. For example, the statistical model 430 may apply a limit on the daily decrease rate of LAI during certain growth stages when LAI normally tends to decrease or can as well limit the LAI of a crop within a viable range specific to that crop and/or growth stage, e.g. FIG. 3. In the machine learning approach (ii), statistical model 430 is essentially a machine learning model, e.g. a random forest regression model or a deep learning model, that performs an improved estimation of LAI. The inputs to such model are therefore not only the current LAI observation undergoing correction and its historical set but a set of auxiliary target-specific information. For example, an implementation of statistical model 430 could involve a machine learning model that has as inputs the current remotely sensed LAI of the field, 4 last available LAI observations of the field, crop growth stage, and weather conditions and outputs an improved/corrected estimation of the field LAI level, as illustrated in FIG. 4. Thus, in the machine learning approach, statistical model 430 treats the auxiliary information as individual model inputs and “learns” the nonlinear relationship between target-specific auxiliary information, and the set of input LAI values on the one hand, and the actual LAI level of the field on the other.

### Calibration of Models:

It is important to note that in case the generic/initial LAI model 300, the crop-specific LAI models 410 and the statistical model 430 are by and large statistical models and therefore need to be calibrated using “ground truth” to be able to perform their individual tasks, i.e. the initial/generic LAI estimation, the crop-specific LAI estimation, and the multi-temporal correction, respectively. While individual calibration of the models 300, 410 and 430 is possible, the preferred approach is to calibrate the entire workflow, including all models within the workflow, so that the error between the predictions of the workflow, and ground-truth observations is minimized:

$$minimize \sqrt{\frac{1}{n} {\sum }_{i = 0}^{n} {( {\hat{y}}_{i} - {y}_{i} )}^{2}}$$

where
y is a ground-truth observation of LAI
ŷ is the final estimation/correction of LAI by the model for the observation

For the preferred embodiment, where satellite images are used, this minimization problem may be solved by optimizing the parameters of the models 300, 410 and 430 given (A) a set of satellite-observed reflectance values, and corresponding field-level auxiliary information as inputs to the workflow and (B) independently estimated field-specific LAI data corresponding spatially and temporally to satellite based observations, serving as the desired output of the workflow. Simply put, the goal of the optimization problem is to identify models 300, 410 and 430 so that the prediction error of the model with respect to in-situ measured LAI is minimized.

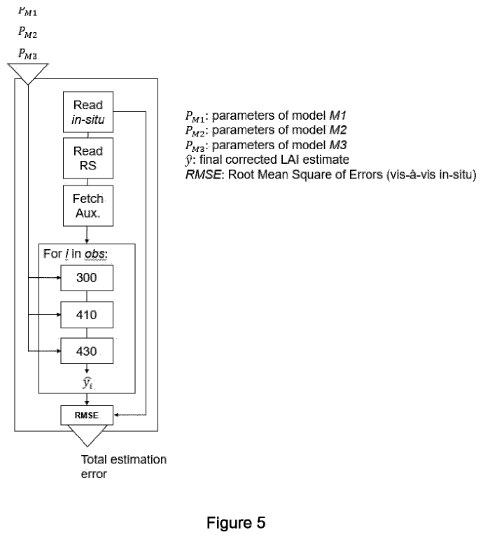

Due to the high dimensionality and non-linearity of the abovementioned optimization problem, metaheuristic approaches may yield superior results. For example, the above-mentioned optimization problem can be implemented in the form of a cost function that inputs parameters of the models 300, 410 and 430 and outputs the total root mean square error of prediction over the entire calibration dataset. Internally, for each field where ground-truth observation is available, the cost function calls the sequence of operations, including reading remotely sensed reflectance data from source, querying the auxiliary data, generic/initial LAI estimation from reflectance, crop-specific corrections, multi-temporal correction, and ultimately calculates the root mean square of errors compared to the ground truth, cf. FIG. 5. Certain requirements, for example, realistic value range, and time-series noise levels and behavior for the resulting LAI may be ensured through imposing penalty on the cost function.

Finally, the optimal inputs of the cost function, i.e. the parameters of the models 300, 410 and 430, may be found using any of the established or devised metaheuristic approaches, for example, evolutionary algorithms such as particle swarm optimization or genetic algorithm. Regardless of the implementation, usually the optimization process involves creating a set, so called “population”, of random solutions to the problem, assessing suitability of results for each solution, and subsequently in each iteration converging towards a better solution by employing mostly biologically-inspired processes such selection, combination, mutation.

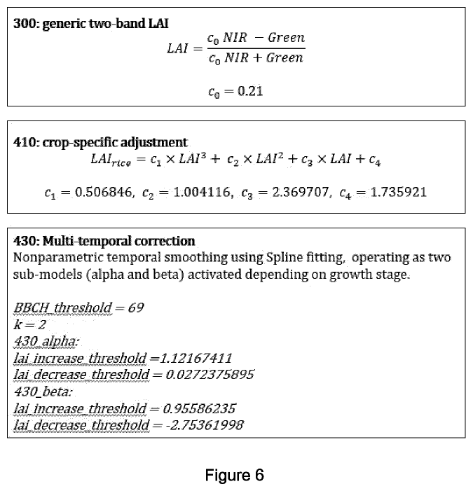

Once the optimal parameterization of the models is identified through the process of optimization, the parametrization is stored and used for subsequent predictions. As an example, a variant of the system may be designed in such a way to use only two bands of a satellite image, namely in green and near infrared region, to estimate the LAI, cf. FIG. 6. The generic/initial LAI is calculated on the satellite image with a mathematical formula with one variable, 4 parameters per crop are used in crop-specific polynomial functions to calculate the crop-specific LAI, and subsequently, and lastly multi-temporal correction is achieved with a spline involving two sub-models and 6 parameters. FIG. 6 presents the calibrated model parameters of each component 300, 410 and 430 in such a system.

### Data Sources and Multi-Source Fusion:

LAI readings/data feeding into the generic/initial LAI calculation/model 300 for comparative multi-temporal correction may be of a variety of sources, including but not limited to past remotely sensed estimates of LAI, direct measurements on the field, proximal reflectance based equipment on the field, and imaging devices using computer vision techniques. Generic/initial LAI calculation/model 300 may have access to such data either through making an active request so that these data are collected, or these data may be available in a farm management system the model 300 may access, or any secondary source the model 300 may query and access.

Similarly, the ground truth readings of LAI which the system may only require during a calibration phase, can also be from different sources. This includes LAI estimations made on the field or remotely and using any technique. Similarly, it is also possible that the so-called ground-truth LAI observation from the field may be obtained from remote sensing, preferably from satellite imagery, or other remote sensing methods, obtained from a different satellite sensor, or even the same satellite sensor and using a different method. For example, the use of certain LAI inversion models can be known to produce high accuracy results, but could be a constraint in terms of computational efficiency or the need for rigorous data from the field. However, the output of such a model may be used as ground-truth to train and calibrate the proposed model. In another example, certain satellite sensors may collect data in certain segments of the spectrum that allow for accurate estimation of LAI. But such estimations would be done at coarse spatial resolution that are not desired, and only possible using sensors equipped with that band. Therefore, despite not being available at all times, these highly accurate remote estimates may also be exploited for the calibration purpose.

Other remote sensing methods may include preferably
remote sensing using aerial vehicles such as aircrafts, airplanes, helicopters, or
remote sensing using unmanned aerial vehicles (UAV) such as drones, or
remote sensing using specialized vehicles or equipment which have direct or indirect contact with the ground.

More preferably, the other remote sensing method is remote sensing using unmanned aerial vehicles (UAV) such as drones.

Another point regarding the source of data may be the source of auxiliary data 500. The auxiliary data may be obtained through secondary sources, including models and direct or indirect measurements, and accessed through active request, or latent query of available data. It is also possible that such auxiliary information, for example, growth stage or field boundaries, are obtained through the application of independent models on the satellite imagery under correction, or the imagery itself alongside other imagery. In other words, some of the auxiliary information may be sourced from the satellite image.

### Calibration Frequency:

Given that enough ground-truth is available, it may be sufficient to calibrate/train the models 300, 410 and 430 in the system/method once or infrequently. One variant of the system/method may be designed in such a way that the models are recalibrated in an automated fashion as new ground-truth dataset becomes available. This can be achieved by triggering the re-calibration on the availability of new ground-truth, or performing the calibration in fixed intervals, or a combination of both. It is also possible to design the automated calibration process in such a way to perform the re-calibration on the entire training dataset, or only the model components and parameters relevant to the newly available dataset. For example, when new ground-truth data is made available on wheat, only recalibrate wheat-specific models using the updated dataset.

Although illustrative examples of the present disclosure have been described above, in part with reference to the accompanying drawings, it is to be understood that the disclosure is not limited to these examples. Variations to the disclosed examples can be understood and effected by those skilled in the art in practicing the disclosure, from a study of the drawings, the specification and the appended claims.

In the claims, any reference signs placed between parentheses shall not be construed as limiting the claim. The term “comprising” does not exclude the presence of elements or steps other than those listed in a claim. The word “a” or “an” preceding an element does not exclude the presence of a plurality of such elements. The disclosure can be implemented by means of hardware comprising several distinct elements. In the device claim enumerating several means, several of these means can be embodied by one and the same item of hardware. The mere fact that certain measured are recited in mutually different dependent claims does not indicate that a combination of these measure cannot be used to advantage.

1. A computer-implemented method for providing corrected plant-related index data, the method comprising:
providing initial plant-related index data for an agricultural field; and
correcting the initial plant-related index data for the agricultural field at least based on historical plant-related index data for the agricultural field and providing corrected plant-related index data.

2. The method according to claim 1, wherein the plant-related index data is: leaf area index (LAI) data, leaf chlorophyll content (LC) data, canopy chlorophyll content (CCC) data, normalized difference vegetation index (NDVI) data, canopy biomass data, canopy nitrogen content data, leaf canopy content data of the plant or vegetation water content data.

3. The method according to claim 1, wherein the plant-related index data is based on satellite images, wherein the satellite images are preferably in the visible and/or near infrared range (NIR).

4. The method according claim 1, wherein the plant-related index data, preferably the initial leaf area index data, for the agricultural field is obtained by using a calibrated mathematical model based on the plant-related index data, preferably the leaf area index data, and surface reflectance bands of the at least one satellite image.

5. The method according to claim 4, wherein the calibrated mathematical model is adapted to different crop varieties, crop types, growth stage, soil conditions and/or data sources.

6. The method according to claim 4, wherein the calibrated mathematical model is a calibrated machine learning model and the plant-related index data for the agricultural field is obtained by using the calibrated machine learning model based on plant-related index data and surface reflectance bands of the at least one satellite image, wherein the machine learning model is preferably: an artificial neural network (ANN), multiple linear regression, random forest regression, or an approach that is able to establish a statistical relationship to predict plant-related index data.

7. The method according to claim 1, wherein the historical plant-related index data of the agricultural field is based on satellite images, wherein the satellite images are preferably in the visible and/or near infrared range (NIR).

8. The method according to claim 1, wherein the historical plant-related index data of the agricultural field comprises satellite images of the agricultural field from a period between 1 and 5 years or satellite images from within the last twelve months, preferably between 2 year and 3 years.

9. The method according to claim 1, wherein the historical plant-related index data of the agricultural field comprises satellite images of the agricultural field from a period between 1 and 30 days, preferably between 1 and 15 days, and especially preferred satellite images from the last 10 days.

10. The method according to claim 1, wherein the historical plant-related index data of the agricultural field comprises satellite images of the agricultural field from the actual growing season starting from the seeding time.

11. The method according to claim 1, further comprising: providing boundary data based on the historical plant-related index data representing boundaries for the corrected plant-related index data.

12. The method according to claim 1, further comprising: providing an uncertainty-probability value based on the historical plant-related index data for the reliability of the corrected plant-related index data.

13. The method according to claim 1, wherein the historical plant-related index data are crop-specific plant-related index data.

14. The method according to claim 1, wherein correcting the initial plant-related index data for the agricultural field is based on a correction term based on a statistical model at least derived from the historical plant-related index data of the agricultural field, and wherein the correction term is additionally based on predefined rules in view of the typical ranges with respect to the crop variety, crop type, growth stage and/or soil condition.

15. (canceled)

16. The method according to claim 1, wherein the correction term is additionally based on at least one crop-specific statistical model, and wherein the dataset constituting the historical plant-related index data is obtained from any combination of different available sources, including satellite images, unmanned aerial vehicles, agricultural robots, handheld or mounted cameras, and/or other measurement devices located on the agricultural field.

17. (canceled)

18. The method according to claim 1, wherein a processor queries, identifies, obtains, standardizes, and outputs the relevant historical plant-related index data of possibly various origins to the correction algorithm.

19. The method according to claim 1, wherein the models estimating plant-related index data from reflectance bands are either continuously or periodically updated, wherein independent measurements of plant-related index data available in the system and their corresponding reflectance bands are fed into a calibration algorithm, wherein the calibration algorithm uses the fed data to improve the performance of the calibrated mathematical model, preferably of the calibrated machine learning model.

20. A system for providing corrected plant-related index data, the system comprising:
at least one input interface for providing initial plant-related index data for an agricultural field; and
at least one processing unit configured to correct the initial plant-related index data for the agricultural field at least based on historical plant-related index data for the agricultural field and providing corrected plant-related index data.

21. A non-transitory computer-readable medium that, when executed by a processor of a system, cause the processor to carry out a method according to claim 1.

22. (canceled)

23. (canceled)

24. A control device for controlling an agricultural equipment based on an application map of an agricultural field based on corrected plant-related index data provided according to claim 1 as input data.
